(19) United States
(12) Patent Application Publication
(10) Pub. No.: US 2024/0070763 A1
(43) Pub. Date: Feb. 29, 2024

(54) SALE OF VIRTUAL GOODS BASED ON PHYSICAL LOCATION

(71) Applicant: Micron Technology, Inc., Boise, ID (US)

(72) Inventors: John D. Hopkins, Milpitas, CA (US); Mohad Baboli, Boise, ID (US)

(21) Appl. No.: 17/899,191

(22) Filed: Aug. 30, 2022

(51) Int. Cl. G06Q 30/06; G06Q 20/32; G06Q 20/40; G06T 19/00; G06V 20/20

(52) U.S. Cl. CPC G06Q 30/0643; G06Q 20/3224; G06Q 20/40155; G06T 19/006; G06V 20/20

(57) ABSTRACT

Methods, apparatus, and non-transitory machine-readable media associated with sale of virtual goods based on physical location are described. An apparatus can include a memory device and a processing device communicatively coupled to the memory device. The processing device can detect a computing device within a threshold radius of a first physical location, display a virtual environment associated with the physical location via a user interface of the computing device, and provide a virtual good for sale via the user interface based on a second physical location of the computing device within the first physical location.

### TECHNICAL FIELD

The present disclosure relates generally to apparatuses, non-transitory machine-readable media, and methods associated with the sale of virtual goods based on physical location.

### BACKGROUND

A computing device can be, for example, a personal laptop computer, a desktop computer, a smart phone, smart glasses, a tablet, a wrist-worn device, a mobile device, a digital camera, and/or redundant combinations thereof, among other types of computing devices.

Augmented reality (AR) can overlay virtual objects on a real-world (e.g., natural) environment. In some examples, AR can be an interactive experience of a real-world environment where real-world objects are enhanced by computer-generated perceptual information. The AR can mask a portion of the real-world environment and/or add to the real-world environment such that it is perceived as an immersive aspect of the real-world environment. Accordingly, AR can alter a person's perception of a real-world environment.

### BRIEF DESCRIPTION OF THE DRAWINGS

FIG. 1 is a functional diagram representing an apparatus including a processing device in communication with a memory device for sale of virtual goods based on physical location in accordance with a number of embodiments of the present disclosure.

FIG. 2 is another functional diagram representing a processing device in communication with a memory device having instructions written thereon in accordance with a number of embodiments of the present disclosure.

FIG. 3 is a flow diagram representing an example method for sale of virtual goods based on physical location in accordance with a number of embodiments of the present disclosure.

FIG. 4 is another flow diagram representing an example method for sale of virtual goods based on physical location in accordance with a number of embodiments of the present disclosure.

FIG. 5 illustrates an example of a virtual good displayed via AR of a computing device in accordance with a number of embodiments of the present disclosure.

### DETAILED DESCRIPTION

Apparatuses, machine-readable media, and methods related to sale of virtual goods based on physical location are described. As the real world becomes more connected to virtual worlds (e.g., the metaverse), users may look for ways to stand out amongst their peers and be unique, both in the real world and a virtual world. For instance, a user may have an avatar in a virtual world that the user would like to be unique and different from other users' avatars. However, digital goods for avatars may not offer uniqueness or scarcity, as users from around the world can access the same virtual (e.g., digital) goods and purchase those virtual goods no matter their physical location.

Examples of the present disclosure can allow for the sale of virtual (e.g., digital) goods based on a geolocation of a user in an AR environment. For instance, a user may enter a brick-and-mortar store and may enable an AR-capable device such as smart glasses, a smartphone, or a tablet. The user can then view and purchase virtual goods for sale within the store based on the user's geolocation. The virtual goods may appear alongside physical goods located within the store. The virtual goods are uploaded to a specified virtual world (e.g., a particular metaverse) and authenticated (e.g., via blockchain) to provide scarcity of the virtual good based on the geolocation of the upload in the store. A purchased virtual good, for instance, can be applied to an avatar to indicate that a physical location was visited to purchase the virtual good. The user can experience the desired uniqueness, while the business can expand customer offerings to virtual goods and draw customers searching for scarce virtual goods.

Examples of the present disclosure can include an apparatus including a memory device and a processing device communicatively coupled to the memory device. The processing device can detect a computing device within a threshold radius of a first physical location, display a virtual environment associated with the physical location via a user interface of the computing device, and provide a virtual good for sale via the user interface based on a second physical location of the computing device within the first physical location.

In the following detailed description of the present disclosure, reference is made to the accompanying drawings that form a part hereof, and in which is shown by way of illustration how one or more embodiments of the disclosure can be practiced. These embodiments are described in sufficient detail to enable those of ordinary skill in the art to practice the embodiments of this disclosure, and it is to be understood that other embodiments can be utilized and that process, electrical, and structural changes can be made without departing from the scope of the present disclosure.

It is also to be understood that the terminology used herein is for the purpose of describing particular embodiments only and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory devices) can refer to one or more memory devices, whereas a “plurality of” is intended to refer to more than one of such things. Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled,” and “coupling” mean to be directly or indirectly connected physically or for access to and movement (transmission) of commands and/or data, as appropriate to the context.

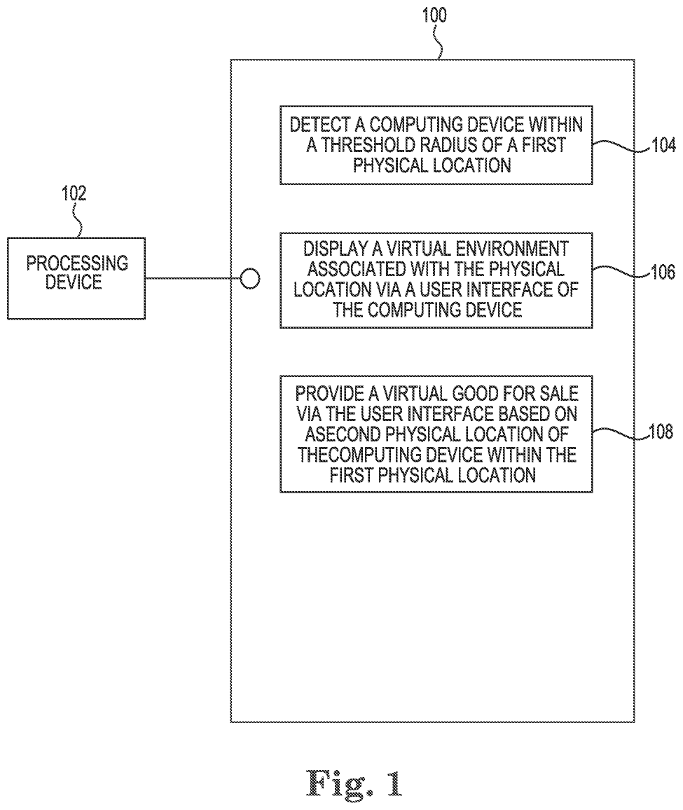

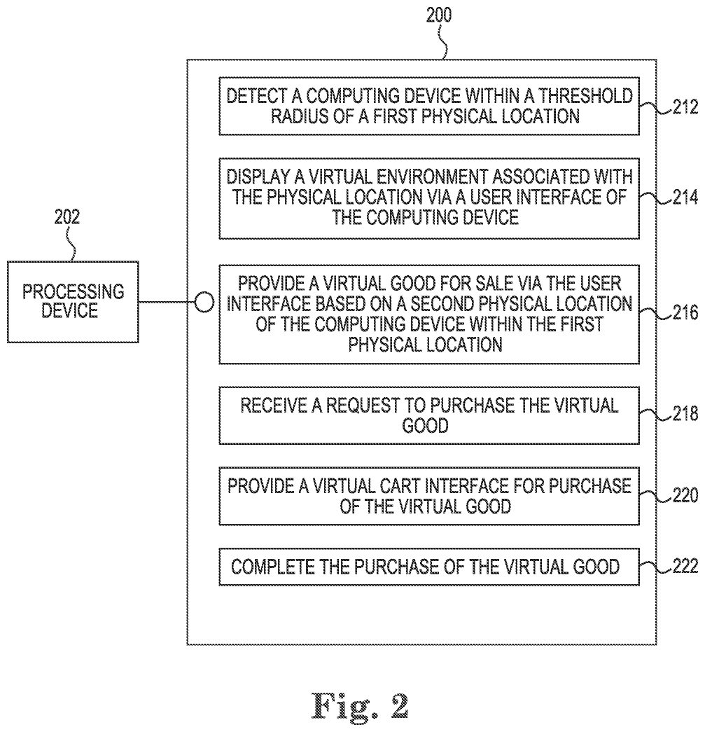

The figures herein follow a numbering convention in which the first digit or digits correspond to the figure number and the remaining digits identify an element or component in the figure. Similar elements or components between different figures can be identified by the use of similar digits. For example, 102 can reference element “02” in FIG. 1, and a similar element can be referenced as 202 in FIG. 2. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

FIG. 1 is a functional diagram representing an apparatus including a processing device 102 in communication with a memory device 100 for sale of virtual goods based on physical location in accordance with a number of embodiments of the present disclosure. The apparatus illustrated in FIG. 1 can be a server or a computing device (among others) and can include the processing device 102 (e.g., a processing resource). The apparatus can further include the memory device 100 (e.g., a non-transitory MRM), on which may be stored instructions, such as instructions 104, 106, 108. The device, in some examples, may be analogous to the device described with respect to FIG. 2 including processing device 202 and memory device 200. Although the following descriptions refer to a processing device and a memory device, the descriptions may also apply to a system with multiple processing devices and multiple memory devices. In such examples, the instructions may be distributed (e.g., stored) across multiple memory devices and the instructions may be distributed (e.g., executed by) across multiple processing devices.

The memory device 100 may be electronic, magnetic, optical, or other physical storage device that stores executable instructions. Thus, the memory device 100 may be, for example, non-volatile or volatile memory. In some examples, the memory device 100 is a non-transitory MRM comprising RAM, an Electrically-Erasable Programmable ROM (EEPROM), a storage drive, an optical disc, and the like. The memory device 100 may be disposed within a controller and/or computing device. In this example, the executable instructions 104, 106, 108 can be “installed” on the device. Additionally, and/or alternatively, the memory device 100 can be a portable, external or remote storage medium, for example, that allows the system to download the instructions 104, 106, 108 from the portable/external/remote storage medium. In this situation, the executable instructions may be part of an “installation package”. As described herein, the memory device 100 can be encoded with executable instructions for sale of virtual goods based on physical location

The instructions 104, when executed by a processing device such as the processing device 102 can include instructions to detect a computing device within a threshold radius of a first physical location. For instance, a user may be on vacation and enter a store at the first physical location. The user and their computing device (e.g., smart glasses, tablet, smartphone, etc.) may be detected by being within a global positioning boundary associated with the first physical location (e.g., enter the store's global positioning system (GPS) boundaries), may be detected by being connected to a communication network associated with the first physical location (e.g., connect to the store's WiFi), or may be recognized as within the threshold radius of the first physical location in another manner.

The instructions 106, when executed by a processing device such as the processing device 102, can include instructions to display a virtual environment associated with the physical location via a user interface of the computing device. Detection of the computing device within the threshold radius, for instance, can trigger launching of the virtual environment via AR. The computing device, for example, may be a smartphone, tablet, smart glasses, or other device having a camera or cameras and AR capabilities.

In a number of embodiments, AR can be used through location services (e.g., GPS, gyroscope, accelerometer, etc.), one or more of the cameras, or a combination thereof. In some examples, one of the cameras can be used solely for AR purposes (e.g., an AR-specific camera). In a number of embodiments, one or more optical sensors can be used with one or more cameras for the AR, or in contrast, one or more optical sensors can be used instead of one or more cameras for the AR. AR can overlay virtual objects on a real-world environment to mask a portion of the real-world environment and/or add to the real-world environment such that it is perceived as an immersive aspect of the real-world environment. In some examples, AR can display and/or automate a number of images and/or enhance an AR image to move and/or change on the user interface. For instance, the AR image can include an image of an object that resides in the real world but is enhanced by computer-generated perceptual information. The AR image (e.g., the virtual environment) can include information that is additive to the natural environment of the object or information that masks the natural environment. In some examples, the AR image can be perceived as an immersive aspect of the real environment (e.g., components of the virtual environment blend into a user's perception of the real word). For example, virtual goods within the virtual environment may only be viewed and/or purchased while the user (and associated computing device) is physically within the threshold radius of the first physical location.

The instructions 108, when executed by a processing device such as the processing device 102, can include instructions to provide a virtual good for sale via the user interface based on a second physical location of the computing device within the first physical location. The virtual good can be displayed for sale, for instance, via AR. For example, a user in the store may move between sections of the store, such as t-shirts, pants, accessories, etc. As the user travels through the store (e.g., to the second physical location), the virtual environment and virtual goods displayed for sale can change. When the user is in the t-shirt section, virtual t-shirts for avatars may be displayed for sale, while virtual hats may be displayed as the user moves to the physical location containing physical hats within the store.

Put another way, the processing device 102, in some examples, can provide a different virtual good for sale via the user interface when the computing device moves to a different, third physical location within the first physical location. That is, as the user moves, new virtual goods can be displayed, for instance via AR. The virtual good can be removed from sale responsive to the computing device leaving the second physical location or the threshold radius of the first physical location. For instance, as the user leaves a certain location of the store and/or leaves the store entirely, the virtual goods are removed and no longer available for purchase.

FIG. 2 is another functional diagram representing a processing device 202 in communication with a memory device 200 having instructions 212, 214, 216, 218, 220, 222 written thereon in accordance with a number of embodiments of the present disclosure. In some examples, the processing device 202 and the memory device 200 comprise a device or apparatus and may be analogous to the processing device 102 and the memory device 200 illustrated in FIG. 1.

The instructions 212, when executed by a processing device such as the processing device 202, can cause detection of a computing device within a threshold radius of a first physical location. For instance, a user (and their computing device) can enter the first physical location (e.g., a sporting event, a store, a festival, etc.) or come within the threshold radius. The detection, for instance, may come from connection of the computing device to a WiFi network or the computing device entering GPS boundaries of the first location, for example.

In some examples, a prompt can be provided to the computing device to display a virtual environment via the user interface of the computing device responsive to detection of the computing device within the threshold radius. The virtual environment may not be displayed in response to a denial response from the user to the prompt. Should the user accept the prompt, the virtual environment can be launched. For instance, the instructions 214, when executed by a processing device such as the processing device 202, can cause the display of a virtual environment associated with the physical location via a user interface of the computing device.

The virtual environment may be presented, for instance, via AR, such that the virtual environment is an overlay of the first physical location. For instance, if the user is at a large sporting event, the virtual environment may include sports memorabilia and/or other virtual goods that are not physically present at the sporting event. For example, the instructions 216, when executed by a processing device such as the processing device 202 can include instructions executable to provide a virtual good for sale via the user interface based on a second physical location of the computing device within the first physical location. In the sporting event example, the user may move to a hat shop (e.g., the second physical location) at the sporting event, where the user can find physical hats for sale, and via the user interface of the computing device, can display virtual hats for sale that the user may purchase for their avatar, for instance.

Put another way, the computing device, in some examples can be a virtual reality device that displays the virtual environment and associated virtual goods via AR. For instance, the virtual good, can be displayed, via AR, as an overlay of the second physical location, and the virtual good can be associated with a physical good within the second physical location. Only a user who was physically present at the second physical location (e.g., the hat shop) can purchase the virtual good (e.g., the virtual hat). When the user leaves the second location, the virtual hats are no longer available for purchase.

In some examples, the memory resource 200 has instructions executable to provide the virtual good for sale responsive to a purchase of an associated physical good in the first physical location. For instance, at a special event, such as a sporting event championship game, a user may purchase a particular physical championship product (e.g., t-shirt, pendant, etc.) in order to have the opportunity to purchase a corresponding particular virtual good. In an example, a user may want the metaverse to know they visited a basketball championship game, so the user can purchase a special edition t-shirt for themselves and for their avatar. Such an example can authenticate the purchases and claim of presence at the event based on times, dates, and locations associated with the virtual good (e.g., pixel data, metadata, etc. via blockchain). That is, the virtual good can be used to authenticate the physical good and vice versa.

The instructions 218, when executed by a processing device such as the processing device 202, can facilitate receipt of a request to purchase the virtual good, and the instructions 220, when executed by a processing device such as the processing device 202, can provide a virtual cart interface for purchase of the virtual good. The instructions 222, when executed by a processing device such as the processing device 202, can complete the purchase of the virtual good, and the purchase of the virtual good can be facilitated using a digital currency, a fiat currency, or both.

For instance, the user may choose to purchase a virtual hat and a physical hat while at the sporting event. The user can purchase the virtual hat using virtual currency while purchasing the physical hat using fiat currency (e.g., a credit card). Other combinations of currency may be used, for instance fiat currency may be used for both, among other payment combinations.

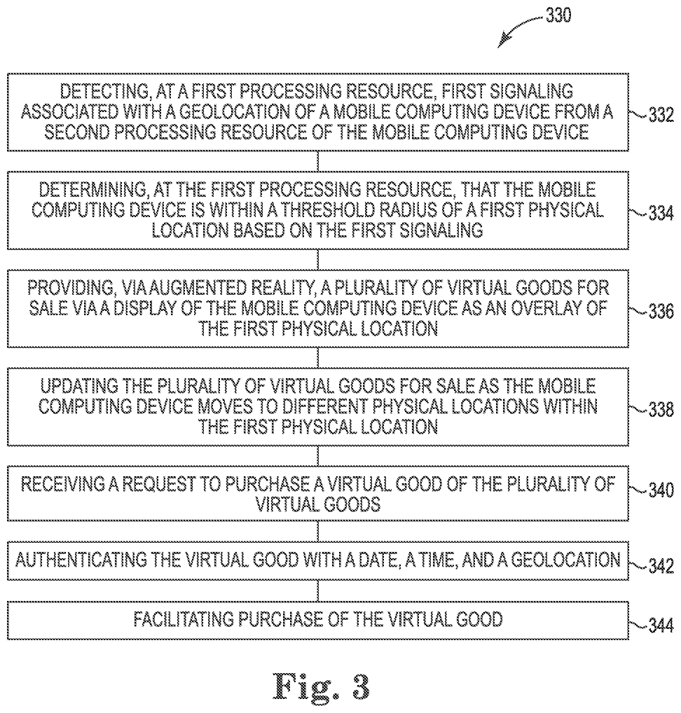

FIG. 3 is a flow diagram representing an example method 330 for sale of virtual goods based on physical location in accordance with a number of embodiments of the present disclosure. The method 330 may be performed, in some examples, using a device such as those described with respect to FIGS. 1 and 2. The method 330 can include the sale of virtual goods based on physical location, which can improve uniqueness, value, and scarcity of virtual goods by requiring a user be in a particular physical location to purchase a particular virtual good.

At 332, the method 330 can include detecting, at a first processing resource, first signaling associated with a geolocation of a mobile computing device from a second processing resource of the mobile computing device. For instance, a geographic location of a user and their associated mobile computing device (e.g., smart glasses, smartphone, tablet, etc.) can be identified using digital information processed via the internet. Examples can include network connections (e.g., WiFi connections), GPS boundaries, network identifiers (e.g., IP addresses), and radio frequency identifiers, among others.

The method 330, at 334, can include determining, at the first processing resource, that the mobile computing device is within a threshold radius of a first physical location based on the first signaling. For instance, when the user and the mobile computing device enter or come within range of the first physical location, the user may gain access to virtual goods. For instance, at 336, the method 330 can include providing, via AR, a plurality of virtual goods for sale via a display of the mobile computing device as an overlay of the first physical location.

The virtual goods, for example, can include digital items not physically available for sale in the first physical location, such as a virtual item for a user's avatar to use, wear, etc. in a virtual world (e.g., metaverse). The virtual item may only be available for purchase when the user is in the first physical location. Put another way, the mobile computing device can be denied access to the plurality of virtual goods responsive to determining the mobile computing device is outside the threshold radius.

At 338, the method 330 can include updating the plurality of virtual goods for sale as the mobile computing device moves to different physical locations within the first physical location. Updating can include, for instance, adding and removing virtual goods of the plurality of virtual goods for sale based on the mobile computing device being in the different physical locations within the first physical location. For example, if the user is in a sporting goods store in the skateboard section, virtual goods associated with skateboarding may be displayed for purchase, but as the user moves towards a baseball section, virtual goods associated with skateboarding can be removed and virtual goods associated with baseball can be added.

At 340, the method 330 can include receiving a request to purchase a virtual good of the plurality of virtual goods. The user can indicate their desire to purchase the virtual good, and the method 330, at 342 can include authenticating the virtual good with a date, a time, and a geolocation. In some examples, the authentication can be done via blockchain, such that the uniqueness and scarceness of the virtual good can be verified. For instance, a user can prove their avatar is using a unique virtual skateboard that can only be purchased by users who physically visit the particular sporting goods store.

The method 330, at 344 can include facilitating purchase of the virtual good. This can include, for instance, accepting a same payment format for the virtual good and a physical good or accepting different payment formats for the virtual good and the physical good. In some instances, the method 330 can include providing the virtual good to an avatar in a metaverse responsive to the purchase (e.g., automatically providing the virtual good). Providing the virtual good may also include providing the authentication data with the virtual good.

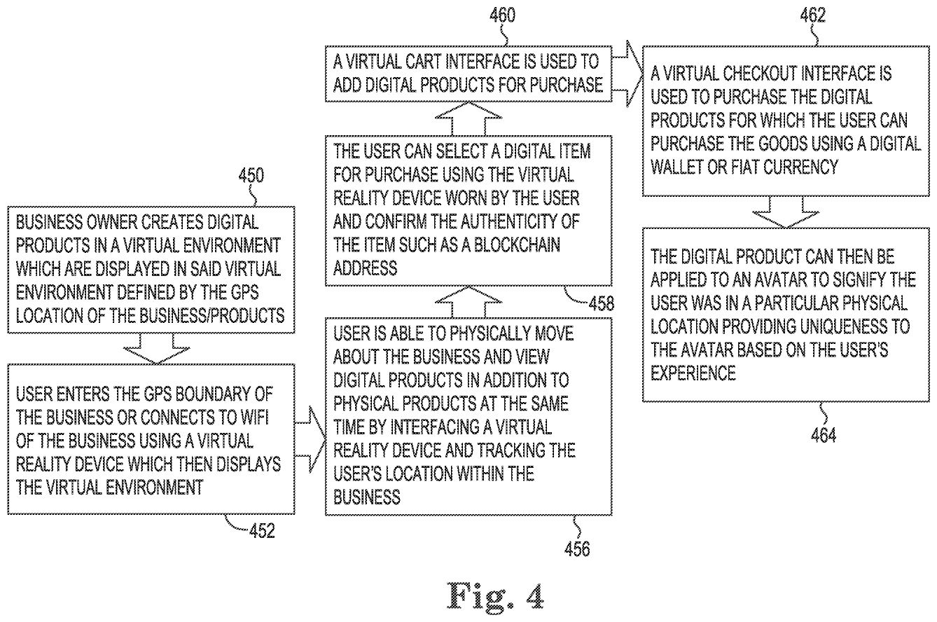

FIG. 4 is another flow diagram representing an example method for sale of virtual goods based on physical location in accordance with a number of embodiments of the present disclosure. The example method may be performed, in some examples, using a device such as those described with respect to FIGS. 1 and 2. The method can include the offering of sale of virtual goods based on physical location, which can improve uniqueness, value, and scarcity of virtual goods by requiring a user be in a particular physical location to purchase a particular virtual good.

At 450, virtual (e.g., digital) goods can be created in a virtual environment and displayed in the virtual environment defined by the GPS location of a particular location. For instance, a business owner can create virtual goods that can only be purchased when a user (e.g., customer) is physically in their business. At 452, when the user enters the GPS boundaries of the business, connects to the business' WiFi, etc., using a virtual reality—capable computing device, the virtual environment and virtual goods of the business can be displayed to the user via a user interface of the computing device.

At 456, the user can physically move around the business and view virtual goods (e.g., digital products) in addition to physical goods and products in the business. The virtual goods displayed can change as the user moves by interfacing the computing device and tracking the user's location within the business. For instance, a user may see virtual socks for their avatar alongside physical socks for themselves, but as the user moves to an outdoor section of the business, virtual coats for an avatar may be displayed, via AR, alongside physical outdoor gear for the user.

At 462, a virtual checkout interface can be presented to the user for purchasing the virtual good. The user may use virtual currency (e.g., digital wallet, etc.), or may use fiat currency, such as a credit card or online payment system. In some instances, if the user purchases physical goods, payment may be made in a same or different manner as the virtual good.

The method, at 464, can include the virtual good being applied to an avatar to signify the user was in a particular physical location when the virtual good was purchased. For instance, if the user was at a business that is a travel “pop-up” high-end fashion shop, the virtual good can provide uniqueness to the user's avatar based on the user's experience and presence at the high-end shop. A timestamp, data, and location data can authenticate the purchase, for instance, via blockchain.

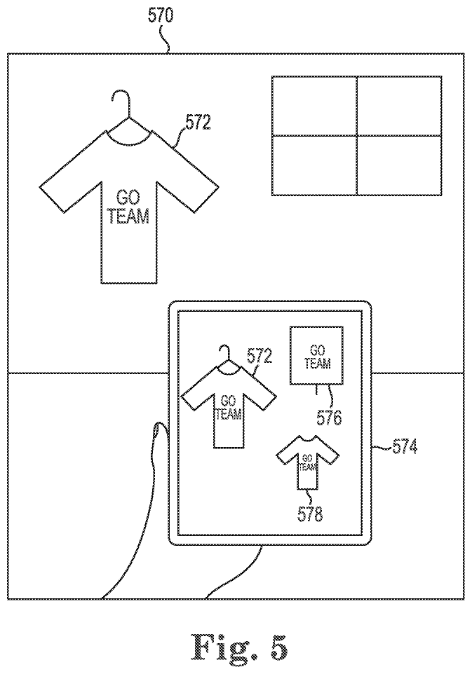

FIG. 5 illustrates an example of a virtual good 576, 578 displayed via AR of a computing device 574 in accordance with a number of embodiments of the present disclosure. The computing device 574 may be a mobile device of a user and may have AR capabilities. The user and the computing device 574 may enter a first physical location 570, such as a retail store. The computing device 574 may be detected and a virtual environment triggered, for instance when the computing device 574 connects to a wireless network of the first physical location 570. In some examples, the computing device 574 may be detected and a virtual environment triggered, for instance when the computing device 574 enters a GPS boundary of the first physical location 570.

Upon triggering the virtual environment, the user, via a display (e.g., user interface) of the computing device 574 can view a physical item 572, as well as virtual goods 576, 578. For instance, a user may search a sporting goods section of a store and find a physical t-shirt 572, as well as a virtual t-shirt 578 and a virtual sign 576 for the user's avatar in the metaverse. The virtual goods 574, 576 displayed may change as the user and the computing device 574 move through the first physical location 570. For instance, a user may move to an accessories section of a retail store, and the virtual goods 574, 576 displayed may change to hats, necklaces, etc. for use in a digital environment.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a memory device; and
a processing device communicatively coupled to the memory device,
wherein the processing device is configured to:
detect a computing device within a threshold radius of a first physical location;
display a virtual environment associated with the physical location via a user interface of the computing device; and
provide a virtual good for sale via the user interface based on a second physical location of the computing device within the first physical location.

2. The apparatus of claim 1, wherein the processing device is configured to display the virtual environment via augmented reality.

3. The apparatus of claim 1, wherein the processing device is configured to display the virtual good for sale via augmented reality.

4. The apparatus of claim 1, wherein the processing device is configured to provide a different virtual good for sale via the user interface when the computing device moves to a different, third physical location within the first physical location.

5. The apparatus of claim 1, wherein the processing device configured to detect the computing device within the threshold radius of a first physical location comprises the processing device detecting that the computing device is connected to a communication network associated with the first physical location.

6. The apparatus of claim 1, wherein the processing device configured to detect the computing device within the threshold radius of the first physical location comprises the processing device detecting that the computing device is within a global positioning boundary associated with the first physical location.

7. The apparatus of claim 1, wherein the processing device is configured to remove the virtual good from sale responsive to the computing device leaving the second physical location or the threshold radius of the first physical location.

8. A non-transitory machine-readable medium comprising a processing resource in communication with a memory resource having instructions executable to:
detect a computing device within a threshold radius of a first physical location;
display a virtual environment associated with the physical location via a user interface of the computing device;
provide a virtual good for sale via the user interface based on a second physical location of the computing device within the first physical location;
receive a request to purchase the virtual good;
provide a virtual cart interface for purchase of the virtual good; and
complete the purchase of the virtual good, wherein the purchased virtual good comprises metadata indicating a time of and the first physical location of the purchase.

9. The medium of claim 8, further comprising instructions executable to provide the virtual good for sale responsive to a purchase of an associated physical good in the first physical location.

10. The medium of claim 8, further comprising instructions executable to:
provide a prompt to the computing device to display the virtual environment via the user interface of the computing device responsive to detection of the computing device within the threshold radius; and
display the virtual environment responsive to an acceptance response to the prompt.

11. The medium of claim 8, further comprising instructions executable to:
provide a prompt to the computing device to display the virtual environment via the user interface of the computing device responsive to detection of the computing device within the threshold radius; and
do not display the virtual environment responsive to a denial response to the prompt.

12. The medium of claim 8, wherein the computing device is a virtual reality device that displays the virtual environment and the virtual good via augmented reality.

13. The medium of claim 8, further comprising the instructions executable to display the virtual good, via augmented reality, as an overlay of the second physical location, wherein the virtual good is associated with a physical good within the second physical location.

14. The medium of claim 8, further comprising the instructions executable to facilitate the purchase of the virtual good using a digital currency, a fiat currency, or both.

15. A method, comprising:
detecting, at a first processing resource, first signaling associated with a geolocation of a mobile computing device from a second processing resource of the mobile computing device;
determining, at the first processing resource, that the mobile computing device is within a threshold radius of a first physical location based on the first signaling;
providing, via augmented reality, a plurality of virtual goods for sale via a display of the mobile computing device as an overlay of the first physical location;
updating the plurality of virtual goods for sale as the mobile computing device moves to different physical locations within the first physical location;
receiving a request to purchase a virtual good of the plurality of virtual goods;
authenticating the virtual good with a date, a time, and a geolocation; and
facilitating purchase of the virtual good.

16. The method of claim 15, further comprising authenticating the virtual good via a blockchain.

17. The method of claim 15, further comprising providing the virtual good to an avatar in a metaverse responsive to the purchase.

18. The method of claim 15, further comprising denying access by the mobile computing device to the plurality of virtual goods responsive to determining the mobile computing device is outside the threshold radius.

19. The method of claim 15, wherein updating the plurality of virtual goods for sale comprising adding and removing virtual goods of the plurality of virtual goods for sale based on the mobile computing device being in the different physical locations within the first physical location.

20. The method of claim 15, wherein facilitating purchase of the virtual good comprises accepting a same payment format for the virtual good and a physical good or accepting different payment formats for the virtual good and the physical good.
